(19) United States
(12) Patent Application Publication
(10) Pub. No.: US 2007/0138702 A9
(43) Pub. Date: Jun. 21, 2007

(54) MOLDED, FILLED POLYMER COMPOSITIONS WITH REDUCED SPLAY AND A METHOD OF MAKING

(75) Inventors: Johannes G.M. Matthijssen, Wouw (NL); Sai-Pei Ting, Slingerlands, NY (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady,, NY (US)

(21) Appl. No.: 10/250,178

(22) Filed: Jun. 10, 2003

Related U.S. Application Data
(63) Continuation-in-part of application No. 10/249,929, filed on May 20, 2003, now abandoned.
Application No. 10/249,929 is a continuation of application No. 10/064,321, filed on Jul. 2, 2002, now Pat. No. 6,593,411.
Application No. 10/064,321 is a continuation of application No. 09/438,998, filed on Nov. 12, 1999, now Pat. No. 6,469,093.

(51) Int. Cl. B29C 45/00

(52) U.S. Cl. 264/328.18; 264/328.1; 524/495; 524/493; 524/449; 524/451; 524/447

(57) ABSTRACT

Molded articles prepared from compositions comprising carbon black have been found to exhibit reduced splay when compared to the corresponding compositions without carbon black. Also provided is a method of reducing splay in a molded article.

### BACKGROUND OF INVENTION

The addition of mineral fillers to polymeric material is known to provide materials having improved physical properties such as increased stiffness. Mineral filled polymeric material may be molded into articles by a variety of techniques including injection molding. The molded articles may be painted or undergo further processing to create a finished article. Other uses require excellent surface appearance of the molded article without further processing in order to avoid additional costs. Therefore, it is desirable that the molded article is free from surface blemishes or other defects.

One such defect encountered in injection molded, filled polymeric material is splay. Splay is manifested as streaking or pale marks at areas on the molded article, particularly adjacent to the location of the mold gate. It is believed that splay occurs when the filled polymeric material is injected into a molding cavity and the material encounters high shear stresses caused by the combination of thickness or dimension variation between the runner and the gate, injection pressure, and a temperature drop from a molten state to the mold temperature. The temperature drop increases the melt viscosity of the filled material, especially at the surface, or skin where splay is manifested.

There remains a need to reduce or eliminate the surface defect of splay that is encountered in molding mineral filled polymeric material while at the same time maintaining good physical properties of articles made from the filled polymeric material.

### SUMMARY OF INVENTION

The above described and other drawbacks and disadvantages of the prior art are alleviated by a composition comprising a polymeric material comprising a poly(arylene ether), a polyamide, a polycarbonate, a polyetherimide, a polysulfone, a polyketone, a poly (alkenyl aromatic), a poly(alkenyl aromatic) copolymer, a polyolefin, a blend of two or more of the foregoing polymeric materials, or a compatibilized blend of two or more of the foregoing polymeric materials; a mineral filler; and greater than or equal to about 1 part by weight carbon black based on the total weight of the composition; wherein the composition exhibits substantially no splay upon visual inspection after molding.

Another embodiment is a method of reducing splay in a molded article comprising molding a composition comprising a polymeric material comprising a poly(arylene ether), a polyamide, a polycarbonate, a polyetherimide, a polysulfone, a polyketone, a poly(alkenyl aromatic), a poly(alkenyl aromatic) copolymer, a polyolefin, a blend of two or more of the foregoing polymeric materials, or a compatibilized blend of two or more of the foregoing polymeric materials; a mineral filler; and greater than or equal to about 1 part by weight carbon black based on the total weight of the composition; wherein the article exhibits substantially no splay upon visual inspection.

### BRIEF DESCRIPTION OF DRAWINGS

FIG. 1 is a photograph of two injection molded articles.

### DETAILED DESCRIPTION OF THE PREFERRED EMBODIMENTS

In one aspect, molded articles comprising a filled polymeric material comprising greater than or equal to about 1 part by weight carbon black based on the total weight of the filled polymeric material exhibit a reduction of splay when compared to molded articles comprising similar compositions not containing carbon black. Not wishing to be bound by any particular theory, it is believed that splay occurs when the filled material is injected into a mold cavity and some of the filler material separates from the polymeric material and agglomerates causing a surface imperfection. When the filled material further comprises carbon black, the carbon black functions as an external lubricant and reduces the friction force between the filled polymeric material melt and the cold mold surface thus improving the surface aesthetic of the molded article by reducing the amount of splay.

“Splay” as used herein describes surface imperfections on a molded article manifested as a pale streak or paleness in color of the surface of the article in relation to its surrounding surface. The location of the splay on the article is generally nearest to the mold gate or the entrance of the mold cavity. Splay can be determined by visual inspection, 60 Â° gloss readings, and reflection haze measurements. 60 Â° gloss values may be determined using ASTM D523. Reflection haze values may be determined using ASTM E430.

In one embodiment, an article formed from the composition exhibits substantially no splay upon visual inspection after molding. The term “substantially no splay upon visual inspection” means that upon visual inspection, the article exhibits a surface substantially uniform in appearance between the gate area and the remainder of the body of the article.

In another embodiment, an article formed from the composition has a first 60 Â° gloss value measured the furthest point on the article from the gate and a second 60 Â° gloss value measured at the gate and the ratio of the first 60 Â° gloss value to the second 60 Â° gloss value is greater than or equal to about 1. Alternatively, a disk with a 10.2 centimeter diameter has a first 60 Â° gloss value measured about 7.5 centimeters from the gate and a second 60 Â° gloss value measured about 2.5 centimeters from the gate and the ratio of the first 60 Â° gloss value to the second 60 Â° gloss value is greater than or equal to about 1.

In another embodiment, an article formed from the composition has a first reflection haze value measured the furthest point on the article from the gate and a second reflection haze value measured at the gate and the ratio of the first reflection haze to the second reflection haze is greater than or equal to about 1. Alternatively, a disk with a 10.2 centimeter diameter has a first reflection haze value measured about 7.5 centimeters from the gate and a second reflection haze value measured about 2.5 centimeters from the gate and the ratio of the first reflection haze to the second reflection haze is greater than or equal to about 1.

In another embodiment, the ratio of the first 60 Â° gloss value to the second 60 Â° gloss value is greater than or equal to about 1 and the ratio of the first reflection haze to the second reflection haze is greater than or equal to about 1.

The filled polymeric material may comprise a variety of polymeric materials, including poly(arylene ether), polyamide, polycarbonate, polyetherimide, polysulfone, polyketone, poly(alkenyl aromatic), poly (alkenyl aromatic) copolymers, polyolefin, blends of two or more of the foregoing, or compatibilized blends of two or more of the foregoing polymeric materials. A preferred polymeric material is a blend of poly (arylene ether) and polyamide, especially compatibilized blends of poly (arylene ether) and polyamide.

The term poly(arylene ether) includes poly(phenylene ether) (PPE) and poly(arylene ether) copolymers; graft copolymers; poly(arylene ether) ether ionomers; and block copolymers of alkenyl aromatic compounds, vinyl aromatic compounds, and poly(arylene ether), and the like; and combinations comprising at least one of the foregoing; and the like. Poly(arylene ether)s are known polymers comprising a plurality of structural units of the formula 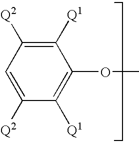
wherein for each structural unit, each Q¹ is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each Q² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms. Preferably, each Q¹ is alkyl or phenyl, especially C₁₋₄ alkyl, and each Q² is independently hydrogen or methyl.

Both homopolymer and copolymer poly(arylene ether)s are included. The preferred homopolymers are those comprising 2,6-dimethylphenylene ether units. Suitable copolymers include random copolymers comprising, for example, such units in combination with 2,3,6-trimethyl-1,4-phenylene ether units or copolymers derived from copolymerization of 2,6-dimethylphenol with 2,3,6-trimethylphenol. Also included are poly(arylene ether)s containing moieties prepared by grafting vinyl monomers or polymers such as polystyrenes, as well as coupled poly(arylene ether) in which coupling agents such as low molecular weight polycarbonates, quinones, heterocycles and formals undergo reaction in known manner with the hydroxy groups of two poly (arylene ether) chains to produce a higher molecular weight polymer. Poly(arylene ether)s suitable for the substrate further include combinations of any of the above.

The poly(arylene ether) generally has a number average molecular weight of about 3,000 to about 40,000 atomic mass units (AMU) and a weight average molecular weight of about 20,000 to about 80,000 AMU, as determined by gel permeation chromatography. The poly (arylene ether) generally may have an intrinsic viscosity of about 0.2 to about 0.6 deciliters per gram (dL/g) as measured in chloroform at 25 Â° C. Within this range, the intrinsic viscosity may preferably be up to about 0.5 dL/g, more preferably up to about 0.47 dL/g. Also within this range, the intrinsic viscosity may preferably be at least about 0.3dL/g. It is also possible to utilize a high intrinsic viscosity poly(arylene ether) and a low intrinsic viscosity poly(arylene ether) in combination. Determining an exact ratio, when two intrinsic viscosities are used, will depend on the exact intrinsic viscosities of the poly(arylene ether)s used and the ultimate physical properties desired.

The poly(arylene ether)s are typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials.

It will be apparent to those skilled in the art from the foregoing that the poly(arylene ether) polymers contemplated for use in the present invention include all of those presently known, irrespective of the variations in structural units.

Specific poly(arylene ether) polymers useful in the present invention include, but are not limited to, poly(2,6-dimethyl-1,4-phenylene ether); poly(2,3,6-trimethyl-1,4-phenylene) ether; poly(2,6-diethyl-1,4-phenylene) ether; poly(2-methyl-6-propyl-1,4-phenylene) ether; poly (2,6-dipropyl-1,4-phenylene) ether; poly(2-ethyl-6-propyl-1,4-phenylene)ether; poly(2,6-dilauryl-1,4-phenylene) ether; poly(2,6-diphenyl-1,4-phenylene) ether; poly(2,6-dimethoxy-1,4-phenylene) ether; poly(2,6-diethoxy-1,4-phenylene) ether; poly(2-methoxy-6-ethoxy-1,4-phenylene) ether; poly(2-ethyl-6-stearyloxy-1,4-phenylene) ether; poly(2,6-dichloro-1,4-phenylene) ether; poly(2-methyl-6-phenyl-1,4-phenylene) ether; poly(2-ethoxy-1,4-phenylene) ether; poly(2-chloro-1,4-phenylene) ether; poly(2,6-dibromo-1,4-phenylene) ether; poly(3-bromo-2,6-dimethyl-1,4-phenylene) ether; mixtures thereof, and the like.

The poly(arylene ether) may be present in the composition in amounts of about 5 to about 60 parts by weight (pbw) based on the total weight of the composition. Within this range the amount of poly(arylene ether) of less than or equal to about 50 pbw can be employed, with less than or equal to about 40 pbw preferred, and less than or equal to about 30 pbw more preferred. Also preferred within this range is an amount of poly(arylene ether) of greater than or equal to about 10 pbw, with greater than or equal to about 15 pbw more preferred, and greater than or equal to about 20 pbw especially preferred.

Polyamides are a generic family of polymeric materials known as nylons, characterized by the presence of an amide group (—C(O)NH—). Nylon-6 and nylon-6,6 are the generally preferred polyamides and are available from a variety of commercial sources. Other polyamides, however, such as nylon-4; nylon-4,6; nylon-12; nylon-6,10; nylon 6,9; nylon 6,12; nylon 6/6T and nylon 6,6/6T with triamine contents below about 0.5 weight percent, as well as others, such as the amorphous nylons may be useful for particular poly(arylene ether)-polyamide applications. Mixtures of various polyamides, as well as various polyamide copolymers, are also useful. The most preferred polyamides are polyamide-6 and polyamide-6,6.

The polyamides can be obtained by a number of well known processes such as those described in U.S. Pat. Nos. 2,071,250; 2,071,251; 2,130,523; 2,130,948; 2,241,322; 2,312,966 and 2,512,606. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylyene diamine, di-(4-aminophenyl) methane, di-(4-aminocyclohexyl)methane; 2,2-di-(4-aminophenyl) propane, 2,2-di-(4-aminocyclohexyl)propane, among others. Copolymers of caprolactam with diacids and diamines are also useful.

Polyamides having viscosity of up to about 400 milliliters per gram (ml/g) can be used, with a viscosity of about 90 to about 350 ml/g preferred, and about 110 to about 240 ml/g especially preferred, as measured in a 0.5 wt % solution in 96 wt % sulfuric acid in accordance with ISO 307.

The polyamide may be present in the composition in amounts of about 95 to about 40 pbw based on the total weight of the composition. Within this range an amount of polyamide of less than or equal to about 90 pbw can be employed, with less than or equal to about 80 pbw preferred, and less than or equal to about 70 pbw more preferred. Also preferred within this range an amount of polyamide of greater than or equal to about 45 pbw, with greater than or equal to about 50 pbw more preferred, and greater than or equal to about 60 pbw especially preferred.

The composition may further comprise a compatibilizing agent to improve the physical properties of the poly(arylene ether)-polyamide blend, as well as to enable the use of a greater proportion of the polyamide component. When used herein, the expression “compatibilizing agent” refers to those polyfunctional compounds which interact with the poly(arylene ether), the polyamide, or, preferably, both. This interaction may be chemical (e.g. grafting) or physical (e.g. affecting the surface characteristics of the dispersed phases). In either case the resulting poly(arylene ether)-polyamide composition appears to exhibit improved compatibility, particularly as evidenced by impact strength, mold knit line strength and/or elongation. As used herein, the expression “compatibilized poly(arylene ether)-polyamide base” refers to those compositions which have been physically or chemically compatibilized with an agent as discussed above, as well as those compositions which are physically compatible without such agents, as taught, for example, in U.S. Pat. No. 3,379,792.

Suitable compatibilizing agents include, for example, liquid diene polymers; epoxy compounds; oxidized polyolefin wax; quinones; organosilane compounds; polyfunctional compounds; polycarboxylic acids such as citric acid, and the like; and functionalized poly(arylene ether)s obtained by reacting one or more of the previously mentioned compatibilizing agents with poly(arylene ether).

The foregoing compatibilizing agents may be used alone or in various combinations of one another with another. Furthermore, they may be added directly to the melt blend or pre-reacted with either or both the poly(arylene ether) and polyamide, as well as with other polymeric materials employed in the preparation of the compositions of the present invention. With many of the foregoing compatibilizing agents, particularly the polyfunctional compounds, even greater improvement in compatibility is found where at least a portion of the compatibilizing agent is pre-reacted, either in the melt or in a solution of a suitable solvent, with all or a part of the poly(arylene ether). It is believed that such pre-reacting may cause the compatibilizing agent to react with the polymer and, consequently, functionalize the poly(arylene ether) as noted above. For example, the poly(arylene ether) may be pre-reacted with maleic anhydride to form an anhydride functionalized poly(arylene ether) which has improved compatibility with the polyamide compared to a non-functionalized poly(arylene ether).

Where the compatibilizing agent is employed in the preparation of the compositions, the initial amount used will be dependent upon the specific compatibilizing agent chosen and the specific polymeric system to which it is added.

The compatibilizing agent may be present in the composition in amounts of about 0.1 to about 3 pbw based on the total weight of the composition. Within this range an amount of compatibilizing agent of less than or equal to about 2 pbw can be employed, with less than or equal to about 1.6 pbw preferred, and less than or equal to about 1.2 pbw more preferred. Also preferred within this range is an amount of compatibilizing agent of greater than or equal to about 0.3 pbw, with greater than or equal to about 0.5 pbw more preferred, and greater than or equal to about 0.7 pbw especially preferred.

The composition further comprises one or more mineral fillers, and optionally non-mineral fillers such as non-mineral low-aspect ratio fillers, non-mineral fibrous fillers, and polymeric fillers. Non-limiting examples of mineral fillers include silica powder, such as fused silica, crystalline silica, natural silica sand, and various silane-coated silicas; boron-nitride powder and boron-silicate powders; alumina and magnesium oxide (or magnesia); wollastonite including surface-treated wollastonite; calcium sulfate (as, for example, its dihydrate or trihydrate); calcium carbonates including chalk, limestone, marble and synthetic, precipitated calcium carbonates, generally in the form of a ground particulate which often comprises 98+% CaCO₃ with the remainder being other inorganics such as magnesium carbonate, iron oxide and alumino-silicates; surface-treated calcium carbonates; talc, including fibrous, modular, needle shaped, and lamellar talcs; kaolin, including hard, soft, calcined kaolin, and kaolin comprising various coatings known to the art to facilitate dispersion and compatibility; mica, including metallized mica and mica surface treated with aminosilanes or acryloylsilanes coatings to impart good physicals to compounded blends; feldspar and nepheline syenite; silicate spheres; flue dust; cenospheres; finite; aluminosilicate (armospheres), including silanized and metallized aluminosilicate; quartz; quartzite; perlite; Tripoli; diatomaceous earth; silicon carbide; molybdenum sulfide; zinc sulfide; aluminum silicate (mullite); synthetic calcium silicate; zirconium silicate; barium titanate; barium ferrite; barium sulfate and heavy spar; particulate or fibrousaluminum, bronze, zinc, copper and nickel; flaked fillers and reinforcements such as glass flakes, flaked silicon carbide, aluminum diboride, aluminum flakes, and steel flakes; processed mineral fibers such as those derived from blends comprising at least one of aluminum silicates, aluminum oxides, magnesium oxides, and calcium sulfate hemihydrate; glass fibers,including textile glass fibers such as E, A, C, ECR, R, S, D, and NE glasses; and vapor-grown carbon fibers include those having an average diameter of about 3.5 to about 500 nanometers as described in, for example, U.S. Pat. Nos. 4,565,684 and 5,024,818 to Tibbetts et al., U.S. Pat. No. 4,572,813 to Arakawa; U.S. Pat. Nos. 4,663,230 and 5,165,909 to Tennent, U.S. Pat. No. 4,816,289 to Komatsu et al., U.S. Pat. No. 4,876,078 to Arakawa et al., U.S. Pat. No. 5,589,152 to Tennent et al., and U.S. Pat. No. 5,591,382 to Nahass et al.; and the like.

Preferred mineral fillers include inorganic fillers that have an average particle size of 5 mm or less and an aspect ratio of 3 or more. Highly preferred mineral fillers include talc, kaolinite, micas (e.g., sericite, muscovite and phlogopite), chlorite, montmorillonite, smectite and halloysite.

The mineral filler is present in the composition in amounts of about 5 to about 50 pbw based on the total weight of the composition. Within this range an amount of mineral filler of less than or equal to about 45 pbw can be employed, with less than or equal to about 40 pbw preferred, and less than or equal to about 35 pbw more preferred. Also preferred within this range is an amount of mineral filler of greater than or equal to about 10 pbw, with greater than or equal to about 15 pbw more preferred, and greater than or equal to about 20 pbw especially preferred. The non-mineral fillers may be used in an amount of about 95 to about 50 pbw based on the total weight of the composition.

Non-limiting examples of non-mineral fillers include natural fibers; synthetic reinforcing fibers, including polyester fibers such as polyethylene terephthalate fibers, polyvinylalcohol fibers, aromatic polyamide fibers, polybenzimidazole fibers, polyimide fibers, polyphenylene sulfide fibers, polyether ether ketone fibers; and the like.

Suitable carbon blacks include conductive carbon black and carbon black having minimal conductivity and are commercially available. Such carbon blacks are sold under a variety of trade names, including but not limited to S.C.F. (Super Conductive Furnace), E.C.F. (Electric Conductive Furnace), Ketjen Black EC (available from Akzo Co., Ltd.) or acetylene black. Preferred carbon blacks are those having average particle sizes less than about 200 nanometers (nm), preferably less than about 100 nm, more preferably less than about 50 nm. Preferred carbon blacks may also have surface areas greater than about 200 square meters per gram (m²/g), preferably greater than about 400 m²/g, yet more preferably greater than about 1000 m²/g. In some embodiments, carbon black is preferred over conductive carbon black.

The carbon black is present in the composition in amounts of about 1 to about 5.0 pbw based on the total weight of the composition. Within this range an amount of carbon black of less than or equal to about 4.0 pbw can be employed, with less than or equal to about 3.5 pbw preferred, and less than or equal to about 3.0 pbw more preferred. Also preferred within this range is an amount of carbon black of greater than or equal to about 1.2 pbw, with greater than or equal to about 1.5 pbw more preferred, and greater than or equal to about 1.9 pbw especially preferred.

Not wishing to be bound by any particular theory, it is believed the carbon black functions as an external lubricant which reduces the friction force between the mineral filler containing polymer melt and the cold mold surface thus improving the surface aesthetic of the molded article by reducing the amount of splay.

The compositions may further comprise impact modifiers, which include natural and synthetic polymer substances that are elastic bodies at room temperature. Examples include, but are not limited to, natural rubbers, butadiene polymers, styrene-isoprene copolymers, butadiene-styrene copolymers (including random copolymers, block copolymers and graft copolymers), isoprene polymers, chlorobutadiene polymers, butadiene-acrylonitrile copolymers, isobutylene polymers, isobutylene-butadiene copolymers, isobutylene-isoprene copolymers, acrylate polymers, ethylenepropylene copolymers, ethylene-propylenediene copolymers, thiokol rubbers, polysulfide rubbers, polyurethane rubbers, polyether rubbers (e.g., polypropylene oxide) and epichlorohydrin rubbers.

These impact modifiers may be prepared by any polymerization method, for example emulsion polymerization and solution polymerization; and with any catalyst, for example peroxides, trialkyl aluminum, lithium halide, and nickel-based catalysts. In addition, impact modifier having various degrees of crosslinking, having microstructures in various ratios (e.g., cis structures, trans structures, and vinyl groups), and having various average rubber particle sizes may be used. The copolymers that can be used may be any type of copolymer, including random copolymers, block copolymers and graft copolymers. In addition, when preparing these impact modifiers, copolymerization with other monomers such as olefins, dienes, aromatic vinyl compounds, acrylic acid, acrylates and methacrylates is also possible. These copolymerization methods include any means, such as random copolymerization, block copolymerization and graft copolymerization. Examples of these monomers that can be cited include, but are not limited to, ethylene, propylene, styrene, chlorostyrene, alpha-methylstyrene, butadiene, isobutylene, chlorobutadiene, butene, methyl acrylate, acrylic acid, ethyl acrylate, butyl acrylate, methyl methacrylate and acrylonitrile. In addition, partially modified impact modifiers can also be used; examples include hydroxy- or carboxy-terminal modified polybutadiene, partially hydrogenated styrene-butadiene block copolymers and partially hydrogenated styrene-isoprene block copolymers.

The impact modifier is present in the composition in amounts of about 2 to about 25 pbw based on the total weight of the composition. Within this range an amount of less than or equal to about 20 pbw can be employed, with less than or equal to about 15 pbw preferred, and less than or equal to about 10 pbw more preferred. Also preferred within this range is an amount of greater than or equal to about 3 pbw, with greater than or equal to about 4 pbw more preferred, and greater than or equal to about 5 pbw especially preferred.

The preparation of the composition is normally achieved by blending the ingredients under conditions for the formation of an intimate blend. Such conditions often include mixing in single or twin-screw type extruders or similar mixing devices which can apply a shear to the components. All of the ingredients may be added initially to the processing system, or else certain additives may be precompounded with one or more of the primary components, preferably the poly (arylene ether) and/or the polyamide. It appears that certain properties, such as impact strength and elongation, are sometimes enhanced by initially precompounding the poly(arylene ether) and impact modifier, optionally with any other ingredients, prior to compounding with the polyamide. It is preferable that at least about 5 weight percent (wt %), preferably at least about 8 wt %, and most preferably at least about 10 wt % polyamide be added with the poly(arylene ether). The remaining portion of the polyamide may be fed through a port downstream. In this manner, the viscosity of the compatibilized composition is reduced without significant reduction in other key physical properties. In a preferred embodiment, the carbon black is precompounded with a portion of the polyamide.

While separate extruders may be used in the processing, these compositions are preferably prepared by using a single extruder having multiple feed ports along its length to accommodate the addition of the various components. It is often advantageous to apply a vacuum to the melt through at least one or more vent ports in the extruder to remove volatile impurities in the composition. Those of ordinary skill in the art will be able to adjust blending times and temperatures, as well as component addition, without undue experimentation.

The composition is suitable for the formation of articles or components of articles using a variety of molding techniques such as, for example, injection molding, blow molding, injection blow molding, stretch blow molding, extrusion, and the like.

It should be clear that compositions and articles made from the compositions made by the method of this disclosure are within the scope of the invention.

It has unexpectedly been discovered that the addition of small amounts of carbon black into mineral filled polymeric compositions provides a molded article exhibiting significantly reduced levels of splay. As mentioned previously, the reduction or elimination of splay in a molded article can be determined by visual inspection of the article. Additionally, the surface appearance of the article may be measured by according to its 60 Â° gloss and/or reflection haze values. These properties have been found to correlate with the amount of splay exhibited by the molded article.

All cited patents, patent applications, and other references are incorporated herein by reference in their entirety. The invention is further illustrated by the following non-limiting examples.

### EXAMPLES 1-3, COMPARATIVE EXAMPLE 1

Unless otherwise indicated below, the materials used in the Examples and Comparative Example are provided in Table 1.

TABLE 1

| Abbreviation | Name | Comment | Source |
|---|---|---|---|
| PPO | Poly(2,6-dimethyl- | Intrinsic viscosity of | General |
| | 1,4-phenylene) ether | 0.46 in chloroform at | Electric |
| | | 25° C. | Company |
| KG1651 | KRATON G | A hydrogenated | Shell |
| | | styrene-ethylene- | Chemical |
| | | butylene-styrene | Company |
| | | copolymer | |
| CA | Citric acid | Compatibilizing agent | Cargill |
| Irg1076 | IRGANOX 1076 | Octadecyl-3,5-di-tert- | Ciba |
| | | butyl-4-hydroxy- | Specialty |
| | | hydrocinnamate | Chemicals |
| KI | Potassium iodide | 33% in H₂O | Ajay |
| CuI | Copper iodide | | Ajay |
| Talc-MB | FINNTALC M15 | 45 weight % talc | Omiya |
| | HF-nylon 66 RMC | 55 weight % nylon 66 | Rhodia |
| | F837 | | |
| PA-66 | Polyamide nylon 66 | | Rhodia |
| | F837 | | |
| PA-6 | Polyamide nylon 6 | | Rhodia |
| | F833 | | |
| CB-MB | carbon black 9A32 | 20 weight % carbon | Cabot |
| | Du Pont prime | black | Clariant |
| | nylon, F6395 | 80 weight % | |
| | | nylon 66 | |

The formulations for the compositions of the Examples are provided in Table 2; all amounts are in parts by weight unless stated otherwise. The compositions for Examples 1-3 (Ex. 1-3) were prepared by dry blending poly(phenylene ether) with KG1651, mineral oil, CA, IR 1076, KI and CuI (this blend is described herein as the PPO dryblend). The PPO dryblend was then compounded with other raw materials such as talc-MB, PA66, PA6, and CB-MB. The compositions were compounded by addition of the PPO dryblend to the feed throat of a 30 mm Werner Pfleiderer twin screw extruder with the addition of the other raw materials downstream using a side feeder. The extruder was equipped with two vacuum vents, a side feeder and reverse flighted, forward flighted and neutral kneading blocks. The extruder was operated with a temperature profile as provided in Table 3, a screw speed of 350 rotations per minute (RPM), and a throughput of 50 pounds per hour (22.7 kilograms per hour).

The amount of carbon black in the Examples can be described two ways: 1. as carbon black loading levels compared to the amount of the entire composition (0.4-2.0 parts by weight based on the total composition; see Table 4) or 2. loading levels of the polyamide-carbon black masterbatch (2.0-10 parts by weight of the carbon black and polyamide masterbatch to the total weight of the composition; see Table 2).

A Comparative Example (C. Ex. 1) was prepared in the same manner as Examples 1-3 with the omission of the carbon black.

TABLE 2

| Components | C. Ex. 1 | Ex. 1 | Ex. 2 | Ex. 3 |
|---|---|---|---|---|
| PPO, 0.46 IV | 24 | 24 | 24 | 24 |
| KG1651 | 6 | 6 | 6 | 6 |
| Mineral Oil | 1 | 1 | 1 | 1 |
| CA | 0.7 | 0.7 | 0.7 | 0.7 |
| Irg1076 | 0.3 | 0.3 | 0.3 | 0.3 |
| KI, 33% in H2O | 0.15 | 0.15 | 0.15 | 0.15 |
| CuI | 0.01 | 0.01 | 0.01 | 0.01 |
| Talc-MB | 43.0 | 43.0 | 43.0 | 43.0 |
| PA 66 | 21.0 | 19.4 | 16.2 | 13.0 |
| PA 6 | 5.0 | 5.0 | 5.0 | 5.0 |
| CB-MB (20% | 0 | 2 | 6 | 10 |
| CB/80% PA66) | | | | |

TABLE 3

| | Barrel | | | | | | | | | | | |
|---|---|---|---|---|---|---|---|---|---|---|---|---|
| | 1 | 2 | 3 | 4 | 5 | 6 | 7 | 8 | 9 | 10 | 11 | Die |
| Temp. | 260 | 280 | 280 | 290 | 290 | 290 | 290 | 290 | 290 | 290 | 290 | 290 |
| ° C. | | | | | | | | | | | | |

The compositions were extruded, pelletized and dried four hours at a temperature of 110 Â° C. before molding. The samples were molded into ISO test specimens by a Van Dorn 85T press with a melt temperature of 299 Â° C. and a mold temperature of 88 Â° C. Tests on molded pieces are as follows with the results found in Table 4.

Splay: The surface appearance of the test specimen was analyzed by visual appearance inspection and rated according to the amount of splay present (moderate, slight, or none).

Reflection Haze: Reflection haze was measured according to ASTM E430-97 at a specular angle of 20 A°. Measurements were taken at a location one inch (2.5 centimeter (cm)) away from the gate (gate) and three inches (7.6 cm) away from the gate (body) of a 4-inch (10.2 cm) diameter Dynatup disc with a thickness of about 3 millimeters using a BYK Gardner 4601 haze-gloss meter. The results provided are the mean value of four test specimens for each Example and Comparative Example and the reflection haze value is displayed logarithmically. A ratio of body haze versus gate haze is also provided in Table 4.

60â° Gloss: 60â° Gloss was measured at a location one inch (2.5 cm) away from the gate area (splay area) and three inches (7.6 cm) away from the gate (normal area) of a 4-inch (10.2 cm) diameter Dynatup disc with a thickness of about 3 millimeters. 60â° Gloss was measured according to ASTM D523 using a BYK Gardner 4601 haze-gloss meter. The results provided are the mean value of four test specimens for each Example and Comparative Example. A ratio of body gloss versus gate gloss is also provided in Table 4.

Vicat softening temperature: The softening temperature in units of Â° C. per hour (Â° C./hr) was measured for 4 millimeter (mm) thick test pieces according to ISO 306 and using an Atlas HDV3 vicat tester.

Izod Notched Impact Strength: The impact strength of test samples was measured according to ISO 180/1A using a Testing Machine Inc. and test pieces of 3.17 mm thickness. The results are shown in units of kilojoule per square meter (KJ/m²).

Dynatup: The Dynatup tests were run according to ASTM D3763 using a Dynatup 8250 at 23 Â° C. and the results are shown in units of Joule (J).

TYS: Tensile yield strength was measured according to ISO 527 using a MTS 5/G and the results are shown in units of megapascal (Mpa).

TE: Tensile elongation (percent (%)) was measured according to ISO 527.

Flex Mod: The Flexural Modulus of the samples was determined according to ISO 178 using a MTS 1125 instrument and the results are displayed in units of Mpa.

Flexural Strength: Flexural strength of the samples was measured according to ISO 178 using a MTS 1125 instrument and the results are shown in units of Mpa.

Density: The specific gravity of the compositions was measured according to ISO 1183 using a Densi Meter from Toyoseiki.

TABLE 4

| | C. Ex. 1 | Ex. 1 | Ex. 2 | Ex. 3 |
|---|---|---|---|---|
| CB loading | 0.0 | 0.4 | 1.0 | 2.0 |
| Gate Splay (visual) | Severe | Severe | Slight | None |
| 60° Gloss (gate) | 4.8 | 5.0 | 5.1 | 7.9 |
| 60° Gloss (body) | 4.1 | 4.8 | 5.5 | 8.5 |
| 60° Gloss (body:gate) | 0.85 | 0.96 | 1.08 | 1.08 |
| Haze (gate) | 28.2 | 36.0 | 36.1 | 56.6 |
| Haze (body) | 24.2 | 35.0 | 38.8 | 57.5 |
| Haze (body:gate) | 0.86 | 0.97 | 1.07 | 1.02 |
| Vicat, 120° C./hr (° C.) | 199 | 199 | 198 | 203 |
| Izod Notched KJ/m² | 5.2 | 5.1 | 5.3 | 5.0 |
| Dynatup @23° C. (J) | 8.1 | 8.5 | 6.1 | 6.5 |
| TYS Mpa | 57 | 58 | 59 | 60 |
| TE % | 12 | 14 | 16 | 13 |
| Flex. Mod. Mpa | 3874 | 3960 | 4003 | 4072 |
| Flex. Str. Mpa | 103 | 105 | 106 | 107 |
| Density | 1.238 | 1.245 | 1.246 | 1.248 |

As shown by the results in Table 4, it was unexpectedly found that the addition of a carbon black (greater than or equal to about 1 part by weight) into a filled poly(phenylene ether)-polyamide blend significantly reduced splay while at, the same time providing no appreciable reduction in physical properties, such as impact strength.

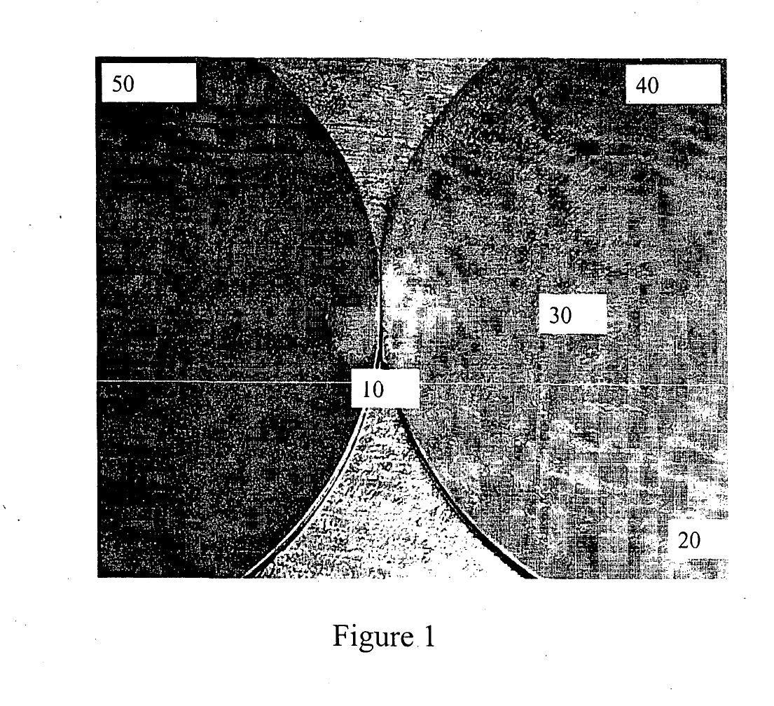

FIG. 1 is a photograph of two injection molded discs. One disc was prepared from the composition of Example 3 (50) having a carbon loading of 2 parts by weight, and the other was prepared from the composition of Example 1 (40) having a carbon black loading of 0.4 parts by weight. As shown, the gate area (10) of the disc prepared from Example 3 (50) resulted in a molded article exhibiting substantially no splay. The disc prepared from Example 1 (40) exhibited some splay (30) at the gate area (10) as compared to the body area (20). Accordingly, it has been shown that greater than or equal to about 1 part by weight carbon black added to a poly(phenylene ether)-polyamide composition results in an unexpected reduction in the amount of splay of a molded article. Furthermore, the reduction of splay occurs without a loss of the desired physical properties of the molded poly(phenylene ether)-polyamide composition as shown by the results in Table 4 for Izod impact strength, tensile yield strength, tensile elongation, flexural modulus, and flexural strength.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A composition, comprising:
a polymeric material comprising a poly(arylene ether), a polyamide, a polycarbonate, a polyetherimide, a polysulfone, a polyketone, a poly(alkenyl aromatic), a poly(alkenyl aromatic) copolymer, a polyolefin, a blend of the foregoing, or a compatibilized blend of the foregoing polymeric materials;
a mineral filler; and
greater than or equal to about 1 part by weight carbon black based on the total weight of the composition;
wherein an article formed from the composition exhibits substantially no splay upon visual inspection after molding.

2. The composition of claim 1, wherein the polymeric material comprises a poly(arylene ether) and a polyamide.

3. The composition of claim 2, further comprising a compatibilizing agent, wherein the compatibilizing agent comprises a liquid diene polymer; an epoxy compound; an oxidized polyolefin wax; a quinone; an organosilane compound; a polyfunctional compound; a polycarboxylic acid; or a combination comprising at least one of the foregoing compatibilizing agents.

4. The composition of claim 1, wherein an article formed from the composition has a first 60° gloss value measured the furthest point on the article from the gate and a second 60° gloss value measured at the gate and the ratio of the first 60° gloss value to the second 60° gloss value is greater than or equal to about 1 and the 60° gloss values are determined by ASTM D523.

5. The composition of claim 1, wherein a disk with a 10.2 centimeter diameter has a first 60° gloss value measured about 7.5 centimeters from the gate and a second 60° gloss value measured about 2.5 centimeters from the gate and the ratio of the first 60° gloss value to the second 60° gloss value is greater than or equal to about 1 and the 60° gloss values are determined by ASTM D523.

6. The composition of claim 1, wherein a disk with a 10.2 centimeter diameter has a first reflection haze value measured about 2.5 centimeters from the gate and a second reflection haze value measured at about 7.6 centimeters away from the gate and the ratio of the first reflection haze to the second reflection haze is greater than or equal to about 1 and the reflection haze values are determined by ASTM E430.

7. The composition of claim 1, wherein an article formed from the composition has a first reflection haze value measured the furthest point on the article from the gate and a second reflection haze value measured at the gate and the ratio of the first reflection haze to the second reflection haze is greater than or equal to about 1 and the reflection haze values are determined by ASTM E430.

8. The composition of claim 1, wherein the poly(arylene ether) comprises a plurality of aryloxy repeating units of the formula 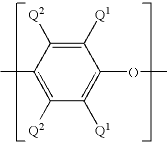
wherein for each structural unit, each Q¹ is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each Q² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms.

9. The composition of claim 1, wherein the poly(arylene ether) comprises poly(2,6-dimethyl-1,4-phenylene ether); poly(2,3,6-trimethyl-1,4-phenylene) ether; poly(2,6-diethyl-1,4-phenylene) ether; poly(2-methyl-6-propyl-1,4-phenylene) ether; poly(2,6-dipropyl-1,4-phenylene) ether; poly(2-ethyl-6-propyl-1,4-phenylene)ether; poly(2,6-dilauryl-1,4-phenylene) ether; poly(2,6-diphenyl-1,4-phenylene) ether; poly(2,6-dimethoxy-1,4-phenylene) ether; poly(2,6-diethoxy-1,4-phenylene) ether; poly(2-methoxy-6-ethoxy-1,4-phenylene) ether; poly(2-ethyl-6-stearyloxy-1,4-phenylene) ether; poly(2,6-dichloro-1,4-phenylene) ether; poly(2-methyl-6-phenyl-1,4-phenylene) ether; poly(2-ethoxy-1,4-phenylene) ether; poly(2-chloro-1,4-phenylene) ether; poly(2,6-dibromo-1,4-phenylene) ether; poly(3-bromo-2,6-dimethyl-1,4-phenylene) ether; or a mixture comprising at least one of the foregoing poly(arylene ether)s.

10. The composition of claim 1, wherein the polyamide comprises nylon-6; nylon-6,6; nylon-4; nylon-4,6; nylon-12; nylon-6,10; nylon 6,9; nylon 6,12; nylon 6/6T; nylon 6,6/6T; or a mixture comprising at least one of the foregoing polyamides.

11. The composition of claim 1, wherein the mineral filler comprises talc, mica, silica, wollastonite, kaolin, feldspar, or a mixture comprising at least one of the foregoing mineral fillers.

12. The composition of claim 1, further comprising an impact modifier.

13. The composition of claim 12, wherein the impact modifier comprises natural rubber, butadiene polymer, styrene-isoprene copolymer, butadiene-styrene copolymer, isoprene polymer, chlorobutadiene polymer, butadiene-acrylonitrile copolymer, isobutylene polymer, isobutylene-butadiene copolymer, isobutylene- isoprene copolymer, acrylate polymer, ethylenepropylene copolymer, ethylene-propylenediene copolymer, thiokol rubber, polysulfide rubber, polyurethane rubber, polyether rubber, epichlorohydrin rubber, styrene-ethylene-butylene-styrene or a mixture comprising two or more of the foregoing impact modifiers.

14. A composition, comprising:
about 5 to about 60 parts by weight of a poly(arylene ether);
about 40 to about 95 parts by weight of a polyamide;
about 0.1 to about 2.0 parts by weight of a compatibilizing agent;
about 5 to about 50 parts by weight of a mineral filler; and
about 1 to about 5.0 parts by weight of carbon black, wherein all amounts are based on the total weight of the composition and a disk with a 10.2 centimeter diameter has a first reflection haze value measured about 2.5 centimeters from the gate and a second reflection haze value measured at about 7.6 centimeters away from the gate and the ratio of the first reflection haze to the second reflection haze is greater than or equal to about 1 and the reflection haze values are determined by ASTM E430.

15. A reaction product of the composition of claim 14.

16. An article formed from the reaction product of claim 15.

17. A composition, comprising:
about 5 to about 60 parts by weight of a poly(arylene ether);
about 40 to about 95 parts by weight of a polyamide;
about 0.1 to about 2.0 parts by weight of a compatibilizing agent;
about 5 to about 50 parts by weight of a mineral filler; and
about 1 to about 5.0 parts by weight of carbon black, wherein all amounts are based on the total weight of the composition and a disk with a 10.2 centimeter diameter has a first 60° gloss value measured about 7.5 centimeters from the gate and a second 60° gloss value measured about 2.5 centimeters from the gate and the ratio of the first 60° gloss value to the second 60° gloss value is greater than or equal to about 0.95 and the 60° gloss values are determined by ASTM D523.

18. A reaction product of the composition of claim 17.

19. An article formed from the reaction product of claim 18.

20. A method of reducing splay in a molded article, comprising:
molding a composition comprising a polymeric material comprising a poly(arylene ether), a polyamide, a polycarbonate, a polyetherimide, a polysulfone, a polyketone, a poly(alkenyl aromatic), a poly(alkenyl aromatic) copolymer, a polyolefin, a blend of two or more of the foregoing, or a compatibilized blend of two or more of the foregoing; a mineral filler; and greater than or equal to about 1 part by weight carbon black based on the total weight of the composition to form an article; wherein a disk with a 10.2 centimeter diameter has a first 60° gloss value measured about 7.5 centimeters from the gate and a second 60° gloss value measured about 2.5 centimeters from the gate and the ratio of the first 60° gloss value to the second 60° gloss value is greater than or equal to about 1 and the 60° gloss values are determined by ASTM D523.

21. The method of claim 20, wherein the composition is prepared by
blending the carbon black with a polyamide to form a first blend;
blending the first blend with a poly(arylene ether), the mineral filler and a compatibilizing agent to form the composition.

22. The method of claim 21, wherein an additional polyamide is blended with the first blend.

23. The method of claim 20, wherein the composition is prepared by
blending carbon black with a first polyamide to form a first blend;
blending the mineral filler with a second polyamide to form a second blend;
blending the first blend and the second blend with poly(arylene ether) and a compatibilizing agent to form the composition.

24. The method of claim 20, wherein molding is injection molding.
TABLE 2

| Components | C. Ex. 1 | Ex. 1 | Ex. 2 | Ex. 3 |
|---|---|---|---|---|
| PPO, 0.46 IV | 24 | 24 | 24 | 24 |
| KG1651 | 6 | 6 | 6 | 6 |
| Mineral Oil | 1 | 1 | 1 | 1 |
| CA | 0.7 | 0.7 | 0.7 | 0.7 |
| Irg1076 | 0.3 | 0.3 | 0.3 | 0.3 |
| KI, 33% in H2O | 0.15 | 0.15 | 0.15 | 0.15 |
| CuI | 0.01 | 0.01 | 0.01 | 0.01 |
| Talc-MB | 43.0 | 43.0 | 43.0 | 43.0 |
| PA 66 | 21.0 | 19.4 | 16.2 | 13.0 |
| PA 6 | 5.0 | 5.0 | 5.0 | 5.0 |
| CB-MB (20% | 0 | 2 | 6 | 10 |
| CB/80% PA66) | | | | |
